(19) United States
(12) Patent Application Publication
(10) Pub. No.: US 2015/0092976 A1
(43) Pub. Date: Apr. 2, 2015

(54) EARPAD

(71) Applicant: HARMAN INTERNATIONAL INDUSTRIES, INCORPORATED, Stamford, CT (US)

(72) Inventors: James KIRSCH, Salt Lake City, UT (US); Jeffrey L. HUTCHINGS, Lehi, UT (US)

(21) Appl. No.: 14/496,732

(22) Filed: Sep. 25, 2014

Related U.S. Application Data
(60) Provisional application No. 61/884,628, filed on Sep. 30, 2013.

(51) Int. Cl. H04R 1/10

(52) U.S. Cl. CPC H04R 1/1058
USPC 381/371

(57) ABSTRACT

An earpad is provided with a base and a sheath. The base is adapted to connect to a headphone housing or an earmuff housing and is formed with a continuous perimeter about a longitudinal axis. The sheath extends from the base and forms a contact surface that is longitudinally spaced apart from the base for engaging a portion of a user's head around an outer ear. The sheath defines a single enclosed cavity for receiving compliant material. The longitudinal spacing of the contact surface corresponds to a depth of the earpad. The depth of the earpad is generally uniform within a first portion of the perimeter of the earpad and increases to an enlarged depth within a second portion of the perimeter of the earpad. The sizing of the earpad may be based on average dimensions of the adult human head.

### CROSS-REFERENCE TO RELATED APPLICATIONS

This application claims the benefit of U.S. provisional application Ser. No. 61/884,628 filed Sep. 30, 2013, the disclosure of which is hereby incorporated in its entirety by reference herein.

### TECHNICAL FIELD

One or more embodiments relate to earpads for circumaural earmuffs and circumaural headphones.

### BACKGROUND

A headphone assembly includes a pair of headphones that each include a small speaker driver that is supported within a housing and designed to be held in place close to a user's ear. Each headphone includes an earpad that is connected to the housing and configured to rest upon a user's ear or head. A supraaural headphone is configured to rest upon the user's ear. A circumaural headphone is configured to rest upon the user's head and surround the ear. Alternatively the headphone may include an in-ear earpad or ear “bud” that is configured to be received within a user's ear.

An earmuff assembly is similar in structure to a headphone assembly in that it includes a pair of earmuffs that each include a housing and an earpad. Earmuffs are configured to protect a user's ears from external sound and are typically configured as circumaural earmuffs without any speakers.

### SUMMARY

In one or more embodiments, a headphone assembly is provided with a housing formed concave with a peripheral edge and an earpad with a continuous perimeter about a longitudinal axis. The earpad includes a base that is connected to the peripheral edge of the housing and a contact surface that is longitudinally spaced apart from the base for engaging a portion of a user's head around an outer ear. The longitudinal spacing of the contact surface corresponds to a depth of the earpad. The depth of the earpad is generally uniform within a first portion of the perimeter of the earpad and increases to an enlarged depth within a second portion of the perimeter of the earpad. The sizing of the earpad may be based on average dimensions of the adult human head.

In another embodiment an earmuff assembly is provided with a housing formed concave with a peripheral edge and an earpad with a continuous perimeter about a longitudinal axis. The earpad includes a base that is connected to the peripheral edge of the housing and a sheath that extends from the base to define an enclosed cavity. The sheath has a contact surface that is longitudinally spaced apart from the base for engaging a portion of a user's head around an outer ear. The longitudinal spacing of the contact surface corresponds to a depth of the earpad. The earmuff assembly also includes at least two layers of compliant material that are disposed within the enclosed cavity and stacked longitudinally such that a first layer is disposed proximate to the contact surface and a second layer is disposed proximate to the base, wherein a hardness of the first layer is less than a hardness of the second layer.

In another embodiment, an earpad is provided with a base and a sheath. The base is adapted to connect to a housing and formed with a continuous perimeter about a longitudinal axis. The sheath extends from the base and forms a contact surface that is longitudinally spaced apart from the base for engaging a portion of a user's head around an outer ear. The sheath defines a single enclosed cavity for receiving compliant material. The longitudinal spacing of the contact surface corresponds to a depth of the earpad. The depth of the earpad is generally uniform within a first portion of the perimeter of the earpad and increases to an enlarged depth within a second portion of the perimeter of the earpad.

### BRIEF DESCRIPTION OF THE DRAWINGS

FIG. 1 is a rear view of an headphone assembly according to one or more embodiments and illustrated worn by a user;

FIG. 2 is a right side view of the user's head;

FIG. 3 is a front perspective view of the headphone assembly of FIG. 1;

FIG. 4 is an inner side perspective view of an earpad of a right headphone of FIG. 1;

FIG. 5 is an inner side elevational view of the earpad of FIG. 4;

FIG. 6 is a bottom view of the earpad of FIG. 4;

FIG. 7 is a front elevational view of the earpad of FIG. 4;

FIG. 8 is a rear elevational view of the earpad of FIG. 4;

FIG. 9 is a top view of the earpad of FIG. 4;

FIG. 10 is a section view of the right headphone of FIG. 3 taken along section line 10-10;

FIG. 11 is a section view of the earpad of FIG. 5 taken along section line 11-11;

FIG. 12 is an enlarged cross-sectional view of a portion of the earpad according to another embodiment; and

FIG. 13 is an enlarged cross-sectional view of a portion of the earpad according to yet another embodiment.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

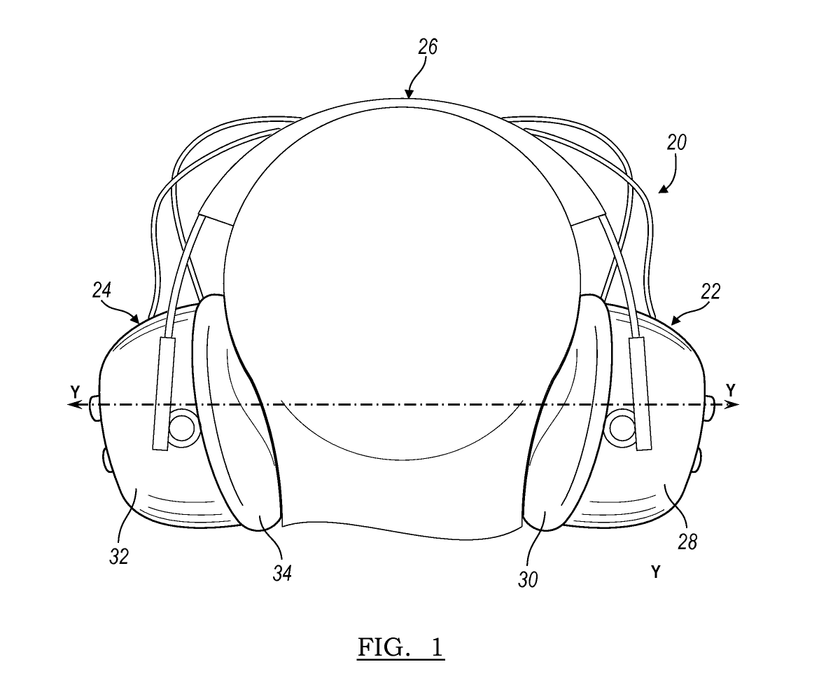

With reference to FIG. 1, a headphone assembly for attenuating sound is illustrated in accordance with one or more embodiments and generally referenced by numeral 20. In general, the headphone assembly 20 is configured to form a seal with the user's head to attenuate external sound and limit air leakage. The headphone assembly 20 includes a speaker driver (as shown in FIG. 10) and may also include digital signal processing capabilities to further attenuate the external sound.

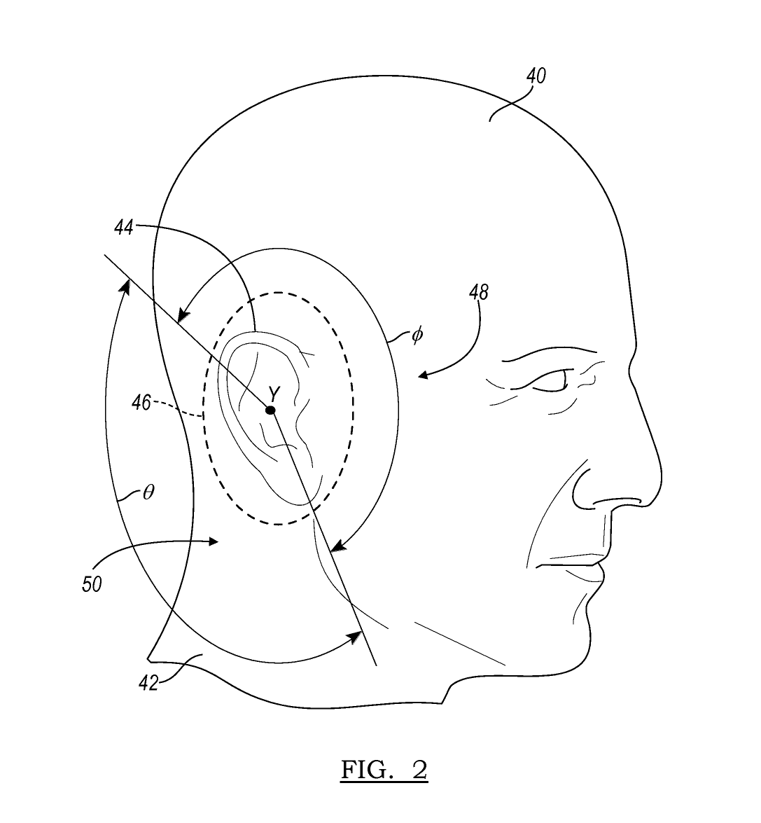

The headphone assembly 20 includes a right headphone 22 and a left headphone 24 that are connected to each other by a bracket 26. The headphones 22, 24 are configured as circumaural headphones such that the right headphone 22 surrounds a right ear (shown in FIG. 2) of the user, and the left headphone 24 surrounds a left ear (not shown) of the user. The right headphone 22 includes a right housing 28 and a right earpad 30 that are connected to each other. The right earpad 30 extends away from the right housing 28 to engage and conform to the right side of the user's head. Similarly, the left headphone 24 includes a left housing 32 and a left earpad 34. The left earpad 34 extends away from the left housing 32 to engage and conform to the left side of the user's head. The earpads 30, 34 are formed of a compliant material. The bracket 26 provides a clamping force to keep the headphones 22, 24 in contact with the user's head, and the earpads 30, 34 elastically deform and conform to the user's head to provide a seal which limits air leakage and attenuates external sound.

FIG. 2 illustrates a side elevational view of the user's head 40, neck 42 and right ear 44. The ear 44 is generally prolate or oblong in shape with a height that is greater than its width. An oval 46 that represents the diameter of a pocket formed by the right earpad (FIG. 1) is illustrated surrounding the ear 44. The oval 46 is generally centered about a longitudinal axis “Y” that extends through both ears 44. A front side surface 48 of the head 40 around an upper and forward portion of the ear 44 and extending between the jawbone and back of the skull is generally flat. This front side surface 48 spans an angular distance about axis Y that corresponds to angle φ. However, a rear side surface 50 of the head 40 and neck 42 behind the ear 44 is recessed as compared to the front side surface 48. This rear side surface 50 spans an angular distance about axis Y that corresponds to angle θ.

Conventional circumaural headphone assemblies (not shown) typically include earpads with a common depth dimension. Such conventional headphone assemblies are prone to air leakage due to the change in depth between the front side surface 48 and the rear side surface 50.

Referring to FIGS. 1 and 2, the headphone assembly 20 includes irregular shaped earpads 30, 34 that vary in depth to correspond with the shape of the user's head 40. Generally, the portion of each earpad 30, 34 that contacts the rear side surface 50 of the user's head 40 is contoured and has a greater depth than the portion of the earpad 30, 34 that contacts the front side surface 48 of the head 40.

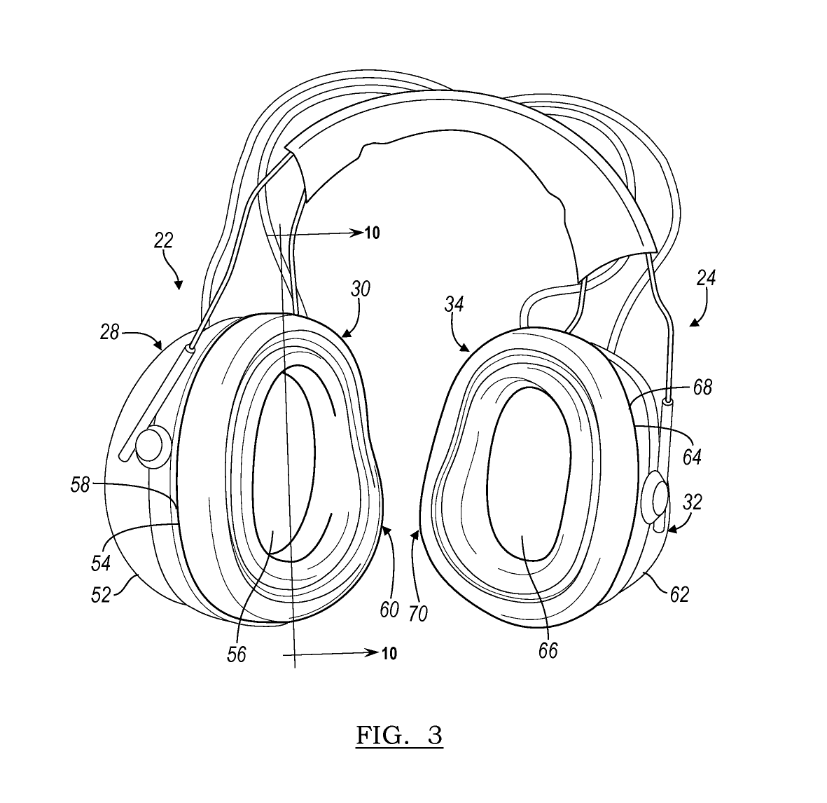

Referring to FIG. 3, the right housing 28 includes an external shell 52 that is concave and disposed over an ear cup 53 (shown in FIG. 10) and forms a peripheral edge 54. The right housing 28 also includes acoustic material (not shown) that is disposed within the ear cup 53, and retained by a liner 56. The bracket 26 is connected to the external shell 52. The right earpad 30 includes a base 58. The base 58 is connected to the peripheral edge 54 of the external shell 52. A contoured portion of the right earpad 30 contacts the rear side surface 50 of the user's head (shown in FIG. 2) and is represented by numeral 60.

Similarly, the left housing 32 includes an external shell 62 that is concave and disposed over an ear cup (not shown) and forms a peripheral edge 64. The left housing 32 also includes acoustic material (not shown) that is disposed within the external shell 62, and retained by a liner 66. The bracket 26 is connected to the external shell 62. The left earpad 34 extends from a base 68 that is connected to the peripheral edge 64 of the external shell 62. A contoured portion of the left earpad 34 contacts the rear side surface of a left side of the user's head and is represented by numeral 70.

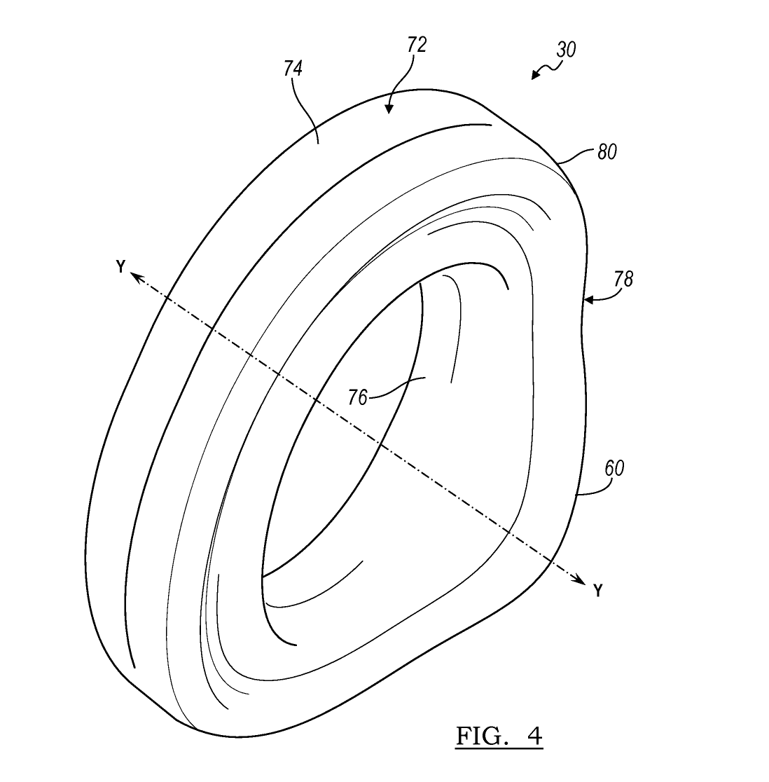

FIG. 4 depicts an enlarged perspective view of the right earpad 30. For brevity, only the right earpad 30 is shown. However, the left earpad 34 (shown in FIG. 3) is generally a mirror image of the right earpad 30. Therefore the following description of the right earpad 30 is generally applicable to the left earpad 34.

The earpad 30 is formed with a continuous perimeter about the longitudinal axis Y. The earpad 30 includes a sheath 72 with an outer side surface 74 and an inner side surface 76 that extend longitudinally from the housing 28 (shown in FIG. 1). The side surfaces 74, 76 are connected to each other by a contact surface 78. The contact surface 78 is longitudinally spaced apart from the housing 28 at a distance that corresponds to a depth of the earpad 30. The contact surface 78 includes a uniform portion 80 and the contoured portion 60. In one or more embodiments, the sheath 72 is formed of a resilient polymer, such as polyurethane, and formed as a unitary structure.

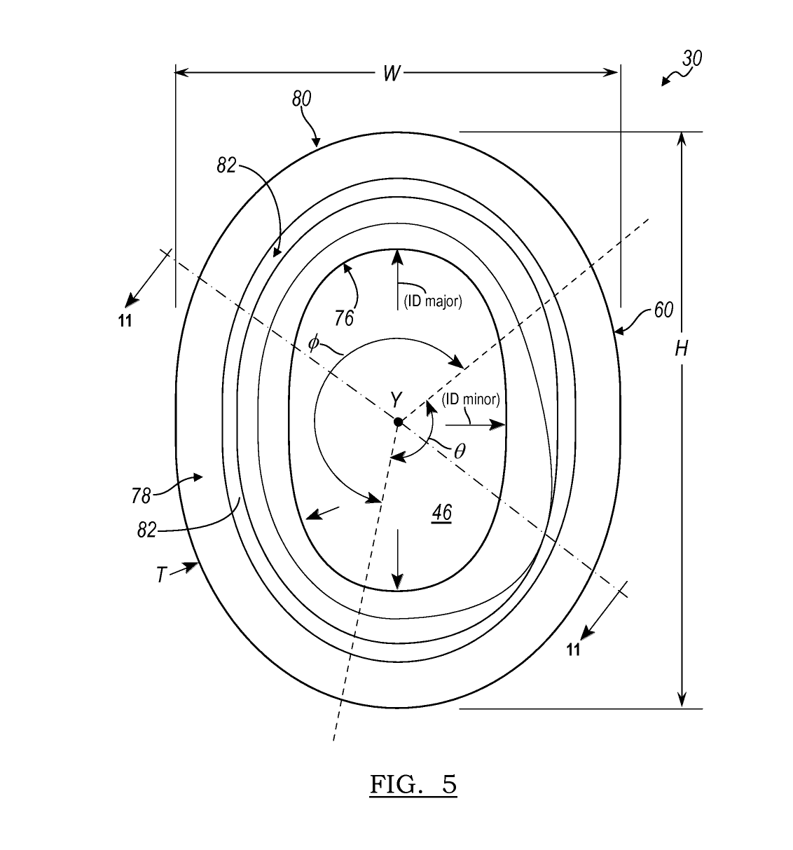

With reference to FIG. 5, the earpad 30 is formed in a non-Euclidian oval shape or “pill-shaped”. In other embodiments the earpad 30 may be formed in a Euclidian shape such as a circle, ellipse or stadium (“racetrack”). The earpad 30 has a height “H” that corresponds to a major outer diameter, and a width (“W”) that corresponds to a minor outer diameter. The earpad also has a thickness (“T”) that is generally uniform around the perimeter of the earpad 30. In one or more embodiments, the earpad 30 is formed with a H of between 100-120 mm, a W of between 75-95 mm and a T of between 19-29 mm. In one embodiment the earpad 30 is formed with a H of approximately 110 mm, a W of approximately 85 mm and a T of approximately 24 mm.

As described above with reference to FIG. 2, the earpad 30 defines a pocket 46 for receiving the ear 44. The pocket 46 is centered about the longitudinal axis Y. The pocket 46 is defined by the inner side surface 76 of the earpad 30, which includes a major inner diameter (“IDₘₐⱼₒᵣ”) and a minor inner diameter (“IDₘᵢₙₒᵣ”). In one or more embodiments, the earpad 30 is formed with an IDₘₐⱼₒᵣ of between 52-72 mm, and an IDₘᵢₙₒᵣ of between 27-47 mm. In one embodiment, the earpad 30 is formed with an IDₘₐⱼₒᵣ of approximately 62 mm, and an IDₘᵢₙₒᵣ of approximately 37 mm.

The uniform portion 80 of the contact surface 78 spans an angle φ about Y, which corresponds to the front side surface 48 of the head 40 in FIG. 2. The contoured portion 60 of the contact surface 78 spans an angle θ which corresponds to the rear side surface 50 of the head 40. In one or more embodiments, angle φ is between 200-220° and angle θ is between 160-140°.

The earpad 30 includes an indentation 82 that is formed into the contact surface 78, according to one or more embodiments. The indentation 82 helps the contact surface 78 conform to the user's head and limit air leakage. The indentation 82 is generally centrally located within the thickness (T) of the earpad 30, and extends to a depth of between 2-10 mm, according to the illustrated embodiment. In other embodiments the earpad 30 includes multiple indentations or no indentations (not shown).

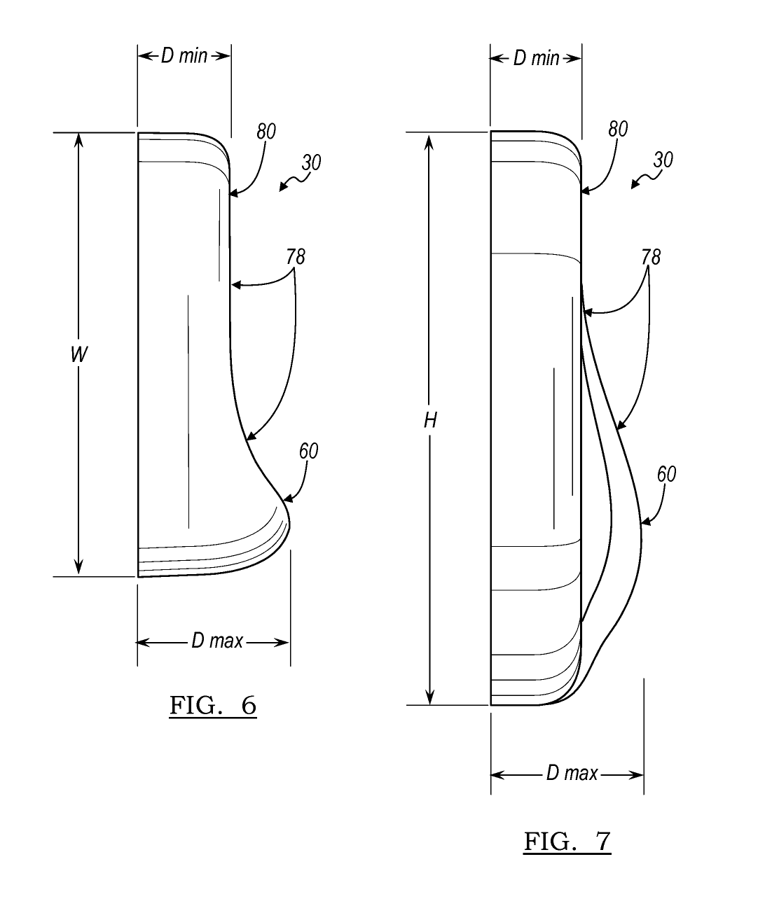

Referring to FIGS. 6 and 7, the contact surface 78 of the uniform portion 80 of the earpad 30 is configured to contact the front side surface 48 of the head 40 (shown in FIG. 2). The uniform portion 80 has a uniform depth which corresponds to a minimum depth of the earpad (“Dₘᵢₙ”). The contact surface 78 of the contoured portion 60 of the earpad 30 is configured to contact the rear side surface 50 of the head 40 and has a variable depth that increases from Dₘᵢₙ to a maximum depth (“Dₘₐₓ”). In one or more embodiments, is between 10-20 mm, Dₘₐₓ is between 15-40 mm and the difference between Dₘᵢₙ and Dₘₐₓ is between 5-20 mm. In one embodiment, Dₘᵢₙ is approximately 15 mm and Dₘₐₓ is approximately 26 mm. The sizing of the earpad 30 is based on average dimensions of the adult human head, according to one or more embodiments.

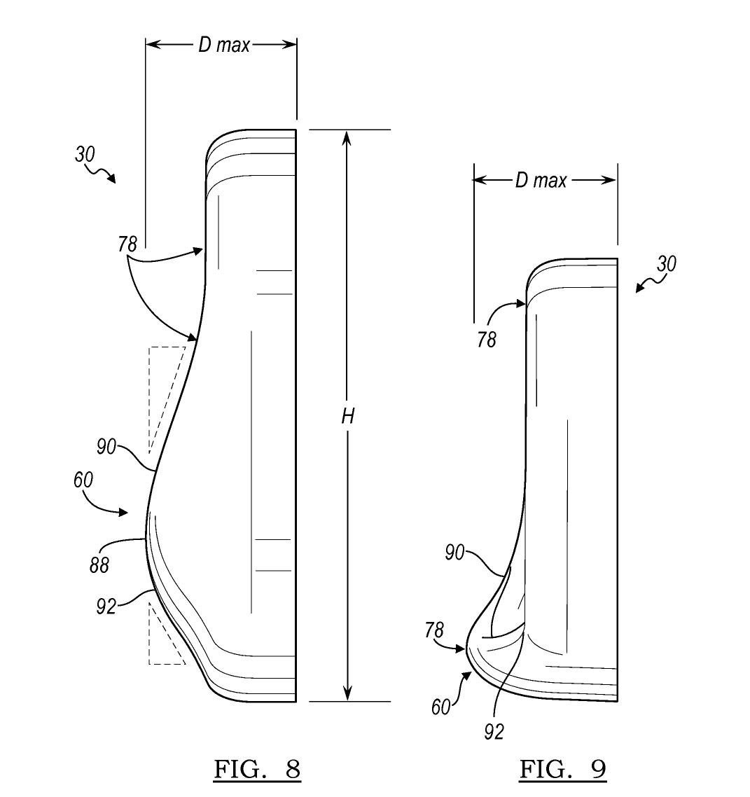

With reference to FIGS. 8 and 9, the slope or grade of the contact surface 78 of the earpad 30 within the contoured portion 60 is different between opposing sides of a peak 88, according to one or more embodiments. The peak 88 of the earpad 30 is the location on the earpad 30 where the depth is equal to Dₘₐₓ. An upper portion 90 of the contact surface 78, as viewed in FIG. 8, has a more gradual slope as compared to a lower portion 92 of the contact surface 78. In one embodiment the slope of the upper portion 90 is approximately 2.2 mm/cm (depth/angular distance) and the slope of the lower portion 92 is approximately 3.1 mm/cm (depth/angular distance). The sizing of the earpad 30 is based on average dimensions of the adult human head, according to one or more embodiments.

FIG. 10 is a section view of the right headphone 22 of FIG. 3 taken along section line 10-10. The external shell 52 is disposed over the ear cup 53. A driver 94, a digital signal processor 96 and a microphone 98 are supported within the ear cup 53, according to one or more embodiments. A clamp ring 100 is connected to an inner portion of the external shell 52 and radially adjacent to the peripheral edge 54. The base 58 includes a tapered disc 102 and a projection 104 that extends from the disc 102 to engage an inner groove 106 formed in the clamp ring 100 for connecting the ear pad 30 to the housing 28.

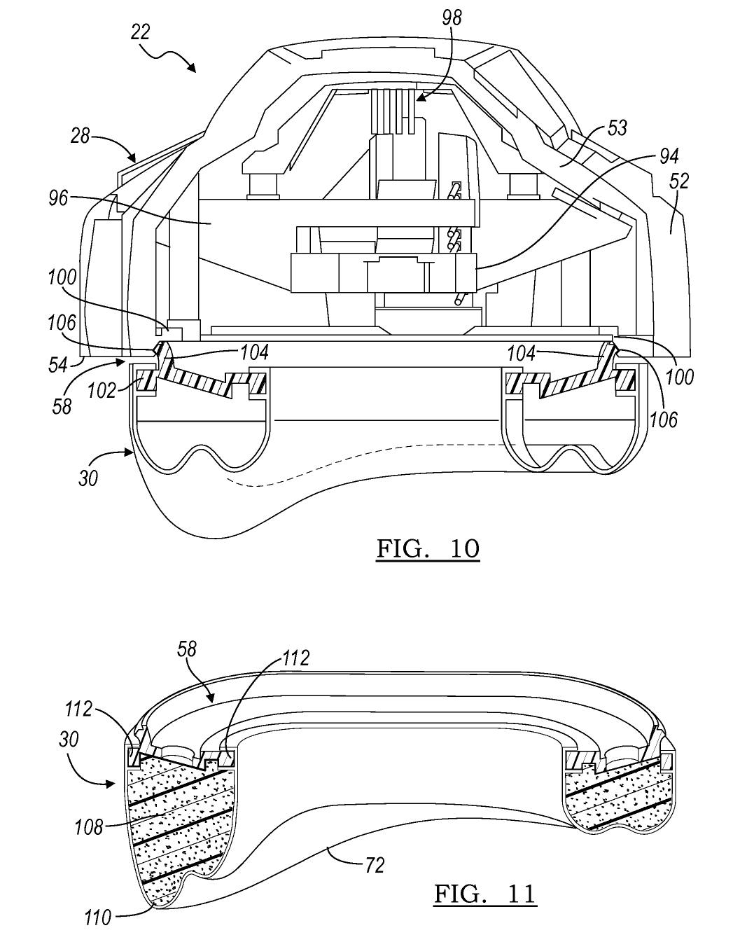

With reference to FIG. 11, the earpad 30 includes compliant material 108 for attenuating sound and providing a comfortable interface with the user's head 40. The sheath 72 extends from the base 58 and defines an enclosed cavity 110 for receiving the compliant material 108. The sheath 72 has a pair of channels 112 formed therein for receiving the disc 102. The disc 102 retains the compliant material 108 within the sheath 72.

In one or more embodiments, the compliant material 108 is a polyurethane gel elastomer having a Shore OOO 28 to Shore OOO 33 hardness, such as MCG-1, which is provided by Northstar Polymers of Minneapolis, Minn. In other embodiments, the compliant material is a viscoelastic foam or “memory foam”, fiber or other dry material.

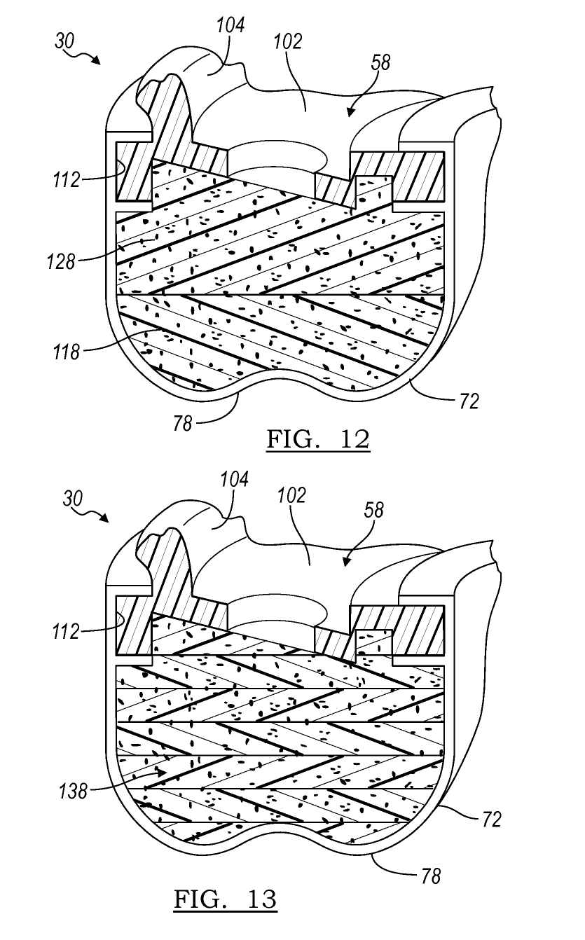

With reference to FIG. 12, the earpad 30 includes two layers of compliant material, according to one or more embodiments. Generally softer materials (e.g., a material with a hardness below Shore 000 33) provide a more comfortable interface with the head; however harder materials (e.g., material with a hardness between Shore OOO 33 and Shore OOO 45) provide better sound attenuation. Therefore, a first layer of compliant material 118 is located in proximity to the contact surface 78 and is formed of a softer material than a second layer of compliant material 128 that is located closer to the base 58. In one embodiment, the first layer of the compliant material 118 is a viscoelastic foam or a synthetic fiber, and the second layer of the compliant material 128 is a polyurethane gel elastomer.

Referring to FIG. 13, in another embodiment, the earpad 30 includes a compliant material 138 having a hardness that varies between the contact surface 78 and the base 58. The compliant material 138 includes a plurality of layers of varying hardness. For example, in one embodiment, the compliant material 138 is a polyurethane gel elastomer, whose composition changes in each layer. The compliant material 138 is disposed within the sheath 72 such that the hardness of the compliant material in the layer near the contact surface 78 is approximately Shore OOO 28 and the gradually increases at each layer to a hardness of approximately Shore OOO 49 at the layer adjacent to the base 58.

The headphone assembly 20 as described above may be used in a number of applications to protect against hearing damage or hearing loss in noisy environments. For example, a user may utilize the headphone assembly 20 at a shooting range, in a manufacturing plant, at a construction site, or at an airport runway.

Further, although the earpad 30 is described for a headphone assembly 20, other embodiments contemplate an earmuff assembly (not shown), that includes a right earmuff with the right earpad 30 and a left earmuff with the left earpad 34.

As such, the headphone assembly 20 provides advantages over the prior art by including an earpad 30 having a contact surface 78 with a depth that changes about a perimeter of the earpad 30 corresponding to the shape of the human head. Such an earpad 30 limits air leakage and attenuates sound. Further, the earpad 30 includes compliant material 108 with two or more layers having different hardness, to provide a contact surface that is comfortable and attenuates sound.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A headphone assembly comprising:
a housing formed concave with a peripheral edge; and
an earpad with a continuous perimeter about a longitudinal axis, the earpad including a base connected to the peripheral edge of the housing and a contact surface longitudinally spaced apart from the base for engaging a portion of a user's head around an outer ear, wherein the longitudinal spacing of the contact surface corresponds to a depth of the earpad;
wherein the depth of the earpad is generally uniform within a first portion of the perimeter of the earpad and increases to an enlarged depth within a second portion of the perimeter of the earpad.

2. The headphone assembly of claim 1 further comprising a first headphone and a second headphone connected to the first headphone by a bracket, wherein each headphone comprises the housing and the earpad.

3. The headphone assembly of claim 1 wherein the first portion of the perimeter of the earpad extends within a range of 200 to 220 degrees about the longitudinal axis.

4. The headphone assembly of claim 1 wherein the second portion of the perimeter of the earpad extends within a range of 160 to 140 degrees about the longitudinal axis.

5. The headphone assembly of claim 1 wherein a maximum depth of the second portion of the perimeter of the earpad is within a range of five to twenty millimeters greater than a maximum depth of the first portion.

6. The headphone assembly of claim 1 further comprising a sheath extending from the base, the sheath defining a single enclosed cavity for receiving compliant material, and wherein the compliant material is formed with a uniform hardness.

7. The headphone assembly of claim 1 further comprising a sheath extending from the base, the sheath defining a single enclosed cavity for receiving compliant material, wherein the compliant material further comprises at least two layers disposed within the enclosed cavity and stacked longitudinally such that a first layer is disposed proximate to the contact surface and a second layer is disposed proximate to the base, wherein a hardness of the first layer is less than a hardness of the second layer.

8. An earmuff assembly comprising:
a housing formed concave with a peripheral edge;
an earpad with a continuous perimeter about a longitudinal axis, the earpad including a base connected to the peripheral edge of the housing and a sheath extending from the base to define an enclosed cavity, the sheath having a contact surface longitudinally spaced apart from the base for engaging a portion of a user's head around an outer ear, wherein the longitudinal spacing of the contact surface corresponds to a depth of the earpad; and
at least two layers of compliant material disposed within the enclosed cavity and stacked longitudinally such that a first layer is disposed proximate to the contact surface and a second layer is disposed proximate to the base, wherein a hardness of the first layer is less than a hardness of the second layer.

9. The earmuff assembly of claim 8 further comprising a first earmuff and a second earmuff connected to the first earmuff by a bracket, wherein each earmuff comprises the housing and the earpad.

10. The earmuff assembly of claim 8 wherein the first layer is formed of a viscoelastic foam and the second layer is formed of a polyurethane gel elastomer.

11. The earmuff assembly of claim 8 wherein the compliant material is formed of a viscoelastic foam.

12. An earpad comprising:
a base adapted to connect to a housing and formed with a continuous perimeter about a longitudinal axis; and
a sheath extending from the base and forming a contact surface that is longitudinally spaced apart from the base for engaging a portion of a user's head around an outer ear, wherein the sheath defines a single enclosed cavity for receiving compliant material;
wherein the longitudinal spacing of the contact surface corresponds to a depth of the earpad, and wherein the depth of the earpad is generally uniform within a first portion of the perimeter of the earpad and increases to an enlarged depth within a second portion of the perimeter of the earpad.

13. The earpad of claim 12 wherein a maximum depth of the second portion of the perimeter of the earpad is within a range of five to twenty millimeters greater than a maximum depth of the first portion.

14. The earpad of claim 12 wherein the first portion of the perimeter of the earpad extends within a range of 200 to 220 degrees about the longitudinal axis.

15. The earpad of claim 12 wherein the second portion of the perimeter of the earpad extends within a range of 160 to 140 degrees about the longitudinal axis.

16. The earpad of claim 12 wherein the compliant material is formed with a uniform hardness.

17. The earpad of claim 12 wherein the compliant material further comprises at least two layers including a first layer disposed adjacent to the contact surface and a second layer disposed between the first layer and the base.

18. The earpad of claim 17 wherein a hardness of the second layer is greater than a hardness of the first layer.

19. The earpad of claim 18 wherein the first layer is formed of a viscoelastic foam and the second layer is formed of a polyurethane gel elastomer.

20. The earpad of claim 12 wherein the compliant material is formed of a polyurethane gel elastomer.
